(19) United States
(12) Patent Application Publication
(10) Pub. No.: US 2016/0174641 A1
(43) Pub. Date: Jun. 23, 2016

(54) PROTECTIVE WEAR FOR REDUCING TRAUMA TO THE HUMAN BODY

(71) Applicant: Leatt Corporation, Santa Clarita, CA (US)

(72) Inventors: Christopher James LEATT, Durbanville (ZA); Scott MACFARLANE, Durbanville (ZA); Jörn Peter STEFFENS, Oldengurg (DE)

(21) Appl. No.: 14/976,209

(22) Filed: Dec. 21, 2015

(30) Foreign Application Priority Data
Dec. 22, 2014 (GB) 1422934.8

(51) Int. Cl. A41D 31/00; B29C 45/00; B32B 3/30; B32B 27/12; A41D 19/015; B32B 5/02

(52) U.S. Cl. CPC A41D 31/0044; A41D 19/01523; B32B 5/02; B32B 3/30; B32B 27/12; B29C 45/0005; B32B 2250/02; B32B 2437/02; B32B 2571/00; B29K 2019/00

(57) ABSTRACT

Protective wear such as a glove comprises a textile fabric substrate with elements of a synthetic plastics material that hardens on being subjected to impact, injection molded onto the fabric. The glove has a row of elements along each digit and some of the elements have recesses in them to provide space for the knuckles and finger joints of the hand.

### CROSS-REFERENCE TO RELATED APPLICATIONS

This application claims the benefit of United Kingdom Patent Application No. 1422934.8, filed on Dec. 22, 2014, which is hereby incorporated by reference for all purposes as if fully set forth herein.

### FIELD OF THE INVENTION

This invention relates to protective wear for reducing trauma to the human body.

### BACKGROUND TO THE INVENTION

Protective wear is used by sportsmen to reduce the severity of the injuries that they would otherwise sustain in the event of an accident and in the absence of such protective wear.

The gloves worn by motorcycle riders are examples of such protective wear. These guard the motorcyclist's hands in the event of them being hit by flying debris or in the event of an accident resulting in the rider being thrown from the motorcycle.

Gloves of this type often comprise a textile fabric substrate to which elements of hard synthetic plastics material are secured. End-to-end elements extend at least along the fingers and thumb of the glove for protecting the rider's knuckles and joints. Elements can also be provided for protecting the bones in the back of the hand.

In conventional gloves the elements are stiff and hard and do not readily conform to the shape of the hand which makes the glove uncomfortable and unwieldy in use.

### SUMMARY OF THE INVENTION

The present invention provides a method of producing protective wear which is more comfortable to use than conventional protective wear while still providing an adequate degree of protection.

The method of the present invention is specifically intended for use in the production of gloves to protect the hands of a motorcyclist but can also be applied to the production of other protective wear such as knee guards, shin guards, elbow guards, and guards for the forearm and ribs.

According to one aspect of the present invention there is provided protective wear comprising a textile fabric substrate which has injection molded onto it an element of a synthetic plastics material which hardens on being subjected to an impact.

Said fabric and said element can have a recess in them which provides space for a part of the human anatomy. The protective wear can be a glove which has, along each finger and thumb, a row of elements for protecting the knuckles, and the finger and thumb joints of the hand.

The recesses of the elements in this form receive the knuckles and joints of the hand.

According to another aspect of the present invention there is provided a method of producing protective wear which comprises molding a protective element onto a fabric which has interstices, the material of the molded element penetrating the fabric to unite the fabric and the element.

The element can be injection molded using a synthetic plastics material.

The synthetic plastic material is preferably one that hardens on impact.

It is also possible to mold said element using a rubber based material.

According to a further aspect of the present invention there is provided a method of producing protective wear which comprises placing a textile substrate in an injection molding cavity, and injection molding a protective element onto the fabric so that the fabric is united with the molded element, the synthetic plastic used being one that hardens on impact.

In one embodiment, the mold cavity be provided with a protrusion which presses into the fabric to form a cavity in the fabric and in that face of the element which is molded onto the fabric.

If the protective wear is a glove, rows of elements are injection molded onto the fabric in a pattern such that they lie along the digits of the glove when the fabric is manipulated into the shape of the glove and fixed in that shape. For some forms of protective wear four rows of protective elements are provided for the fingers.

The cavities formed in the element can accommodate the knuckles of the hand and the joints of the fingers and the thumb.

### BRIEF DESCRIPTION OF THE DRAWINGS

For a better understanding of the present invention, and to show how the same may be carried into effect, reference will now be made, by way of example, to the accompanying drawings in which:

FIG. 1 is a top plan view of one component of a glove according to one embodiment; and

FIG. 2 is a section view of the glove along the line II-II of FIG. 1.

### DETAILED DESCRIPTION OF THE DRAWINGS

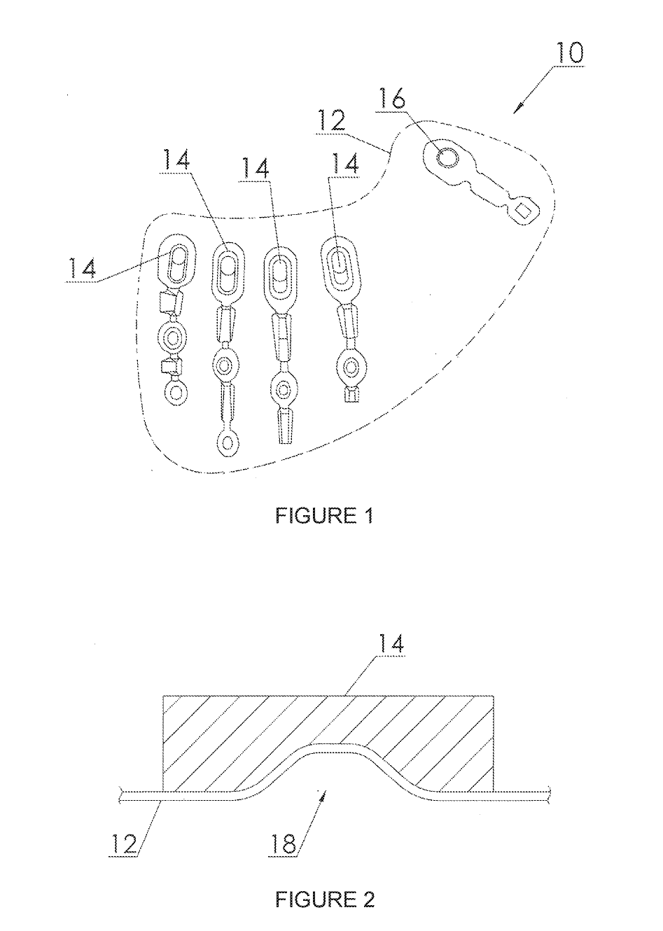

The glove component 10 shown in FIG. 1 comprises a piece of fabric 12 which can be woven or knitted or can be a mesh. The fabric 12 has interstices which, as will be described, are entered by synthetic plastics material thereby to bond the synthetic plastics material to the substrate. The component 10 forms the back of a glove.

Four rows 14 of protective elements are illustrated in FIG. 1. The rows 14, when the part of the fabric 12 between, and on each side of, the rows are sewn to a second layer of fabric or leather forming the palm side of the glove, lie along the fingers of the glove.

The row of protective elements 16 lies along the thumb of the glove once the fabric 12 has been manipulated to the shape of the glove.

To accommodate the knuckles and joints of the hand, each element 16 is, where appropriate, formed with a recess in the underside thereof. This is shown in FIG. 2 where the recess is designated 18. The mold has rounded protuberances over which the fabric is stretched before the mold is closed. The mold cavities, bounded on one side by the mold itself and on the other side by the fabric 12, replicate the elements 16 which are required along the backs of the fingers and thumb of the glove.

The synthetic plastics material used in the rows 14, 16 of protective elements is sometimes referred to as “non-Newtonian” or “dilatant” as its behavior does not obey the usual laws. On being subjected to an impact it immediately hardens. However, before the impact occurs, the synthetic plastics material is relatively soft and pliable. This makes the protective wear according to the invention less stiff and difficult to use than conventional protective wear which, on initial manufacture, has all the protective characteristics required and does not develop them only when needed.

We claim:

1. A protective wear comprising a textile fabric substrate which has injection molded onto it an element of a synthetic plastics material which hardens on being subjected to an impact.

2. The protective wear according to claim 1, wherein said fabric and said element have a recess in them which provides space for a part of the human anatomy.

3. The protective wear according to claim 2, which is in the form of glove which has, along each digit, a row of elements for protecting the knuckles, and the finger and thumb joints of the hand.

4. The protective wear according to claim 2, which is in the form of the glove having four rows of elements for protecting the knuckles and finger joints of the hand.

5. A method of producing protective wear which comprises molding a protective element onto a fabric which has interstices, the material of the molded element penetrating the fabric to unite the fabric and the element.

6. The method according to 5, wherein said element is injection molded using a synthetic plastics material.

7. The method according to claim 5, wherein said element is molded using a rubber based material.

8. A method of producing protective wear which comprises placing a textile substrate in an injection molding cavity, and injection molding a protective element onto the fabric so that the fabric is united with the molded element, the synthetic plastic used being one that hardens on impact.

9. The method according to claim 8, wherein the mold cavity is provided with a protrusion which presses into the fabric to form a cavity in the fabric and in that face of the element which is molded onto the fabric.

10. The method according to claim 8, wherein the protective wear is a glove, five rows of elements being injection molded onto the fabric in a pattern such that they lie along the fingers and thumb of the glove when the fabric is manipulated into the shape of the glove and fixed in that shape.
